(19) United States
(12) Patent Application Publication
(10) Pub. No.: US 2001/0045324 A1
(43) Pub. Date: Nov. 29, 2001

(54) Oil-drip catcher

(76) Inventor: Maurice B. Harding JR., Seattle, WA (US)

Correspondence Address: Mark W. Roberts, Esq., DORSEY & WHITNEY LLP, 1420 Fifth Avenue, Suite 3400, Seattle, WA, 98101, US

(21) Appl. No.: 09/865,928

(22) Filed: May 24, 2001

Related U.S. Application Data
(60) Provisional application No. 60/207,053, filed on May 25, 2000.

(51) Int. Cl. F16N 31/00

(52) U.S. Cl. 184/106

(57) ABSTRACT

An inexpensive and replaceable fluid absorbing device for capturing fluid leaked from a machined assembly such as an oil pan or transmission is described. The device includes an absorbent material that absorbs the leaked fluid, which is attached to the first mounting strip and the first mounting strip is attached to a second mounting strip. The second mounting strip is attached to an exterior portion of the machined assembly. When the first mounting strip is attached to the second mounting strip, the absorbent material is positioned at a location where fluid leaked from the machined assembly is absorbed by the absorbent material. Once saturated with fluid, the device can be removed by simply detaching the first mounting strip from the second mounting strip and a new device can be attached.

### CROSS-REFERENCE TO RELATED APPLICATION

This application claims the benefit of U.S. provisional application No. 60/207,053 filed May 25, 2000.

### TECHNICAL FIELD

The invention relates generally to the field of fluid absorbing devices, and more particularly to a device for attaching to an oil pan or transmission pan to absorb oil or transmission fluid that leaks from the gasket seals of these component parts.

### BACKGROUND OF THE INVENTION

Virtually all fossil-fuel-powered land vehicles, such as automobiles, trucks, buses, trains, tractors, and motorcycles, have engines that are internally lubricated with oil. Typically, an oil pan is mounted to the bottom of the engine, and an oil pump is disposed within or near the oil pan. While the engine is not running, the pan acts as a reservoir for the oil. While the engine is running, the oil pump circulates the oil from the pan up into the cylinders and other internal regions of the engine in need of lubrication, and then the oil flows back into the pan and is again circulated by the pump.

Unfortunately, the oil often leaks from various regions of the engine and drips onto the ground. For example, common regions from which oil may leak are the gasket seal between the rocker-arm covers and the engine, the main-bearing seals, and the gasket seal between the oil pan and the engine. Although these gaskets and seals are intended to provide a leak-proof seal, they often break down over time and allow oil to leak. Typically, this leaking oil flows down the sides of the engine, onto and down the sides of the oil pan, and then drips from the oil pan onto the ground. While the vehicle is moving, the air flow beneath the vehicle may blow the dripping oil onto other portions of the vehicle, such as a rear wheel differential. The blown oil may then drip to the ground from that portion of the vehicle.

One problem with the dripping engine oil is that it often creates a dirty, greasy, or slick area on the surface over which the car is parked. For example, such areas are clearly visible in most public parking spaces and private garages.

Another problem is that the dripping oil, whether it drips onto a parking surface or a roadway, often pollutes the environment as rain washes it into the soil or water ways. In fact, many consider dripping engine oil a serious environmental hazard.

In addition, types of oil other than engine oil may drip from a vehicle and cause problems similar to those discussed above. For example, transmission oil may leak from regions of the transmission including the gasket seal between the transmission oil pan and the transmission housing. The leaking transmission oil flows onto the transmission oil pan, and then drips or is blown from the transmission oil pan onto the ground. Likewise, differential oil may leak from regions of the rear-wheel differential including the gasket seal between the front and rear portions of the differential housing. The leaking differential oil drips or is blown from the differential housing onto the ground.

### SUMMARY OF THE INVENTION

In one aspect of the invention, an oil-drip catcher includes an oil-absorbent material that is removably attachable to a region near an oil-pan or other type of machined assembly having a fluid retaining joint, such as a seal or gasket. The material absorbs the oil that leaks from the joint gasket or from other places above the gasket before the leaking oil can drip to the ground. One can replace the material when it becomes saturated with oil.

One advantage of such an oil-drip catcher is that because it can be positioned near and beneath an oil-pan gasket, the catcher can absorb leaking oil before it can drip or be blown onto the ground. Furthermore, such an oil-drip catcher is relatively inexpensive, easy to install, easy to replace, and can remain on the vehicle while the vehicle is being driven.

### BRIEF DESCRIPTION OF THE DRAWINGS

FIGS. 1-4 are views of an oil-drip catcher attached to an engine oil pan according to an embodiment of the invention.

FIG. 5 is a cross-sectional view of the oil-drip catcher of FIGS. 1-4 according to an embodiment of the invention.

FIGS. 6 and 7 are views of an oil-drip catcher attached to a transmission oil pan according to an embodiment of the invention.

FIG. 8 is a side view of an oil-drip catcher that can be used for the oil-drip catcher of FIGS. 1-7 according to an embodiment of the invention.

FIG. 9 is a cross-sectional end view of the oil-drip catcher of FIG. 8.

FIG. 10 is a side view of an oil-drip catcher that can be used for the oil-drip catcher of FIGS. 1-7 according to another embodiment of the invention.

FIG. 11 is a cross-sectional end view of the oil-drip catcher of FIG. 10.

### DETAILED DESCRIPTION OF THE INVENTION

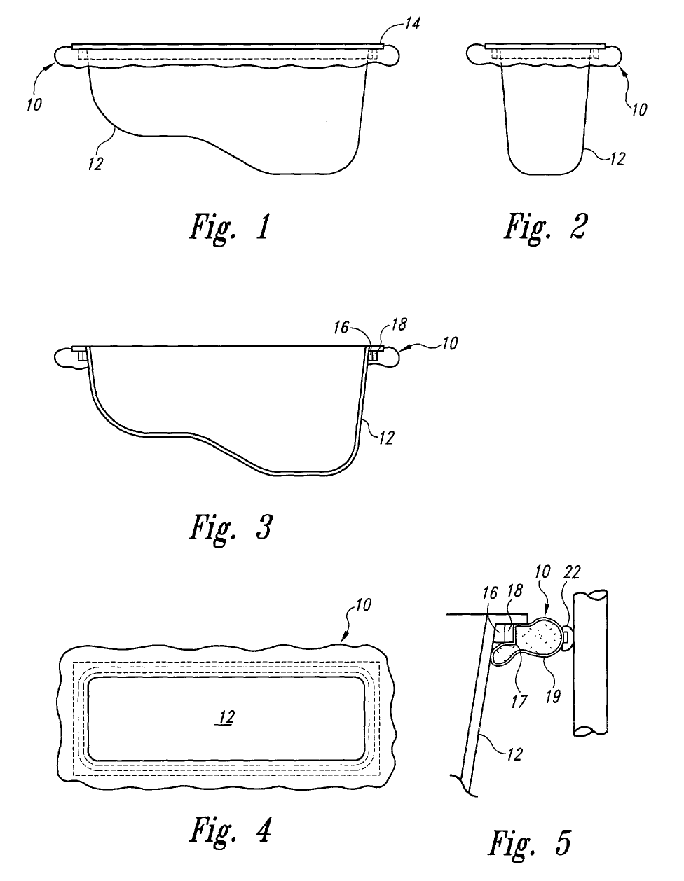

Referring to FIGS. 1-4, FIG. 1 is a side view, FIG. 2 is an end view, FIG. 3 is a cross-sectional view, and FIG. 4 is a bottom plan view of an oil-drip catcher 10 attached to an engine oil pan 12 according to an embodiment of the invention. The catcher 10 is mounted beneath a flange 14 of the pan 12, and typically is wrapped all the way around the pan 12. The flange 14 is typically where the pan 12 is mounted to the bottom of an engine (not shown) with bolts (not shown). An oil-pan gasket (not shown) forms a seal between the flange 14 and the engine. Unfortunately, as discussed above, sometimes the gasket wears out and allows oil to leak from the inside of the engine onto the pan 12. In addition, oil may leak from other regions of the engine and drip down the sides of the engine toward the oil pan. But because the pan 12 is typically the lowest point of the engine, leaking oil drips down the sides of and onto the pan 12 before it drips to the ground. Therefore, by mounting the catcher 10 beneath and around the flange 14, the catcher 10 absorbs the leaking oil before it can drip down the sides of the pan 12 and onto the ground. Furthermore, by mounting the catcher 10 close to the flange 14, the catcher 10 absorbs the leaking oil before it can be blow from the sides of the pan 12 onto the ground.

Still referring to FIGS. 1-4, the oil-drip catcher 10 may be attached to the oil pan 12 in a number of ways. For example, referring to FIG. 3, a first mounting strip 18 having interlocking fabric hooks and loops (i.e., Velcro®) is attached to the catcher 10 and a second mounting strip 16 also having interlocking fabric hook and loops is attached to the oil pan. Therefore, one attaches the strip 18 to the strip 16 to secure the catcher 10 to the oil pan 12. In a preferred embodiment, the interlocking fabric hooks and loops include Velcro® H88 products in ½ inch, ⅝ inch or ¾ inch widths, available as product numbers 0174 (hook) and 0199 (loops). In a preferred practice, the hook product is attached to the machined assembly and the loop product is attached to the absorbent material, however, the reverse is also suitable. Alternatively, one may use other techniques for attaching the catcher 10 to the pan 12. For example, the second mounting strip 16 may be attached securely to the pan using the screws or bolts used to attach the pan 12 to the engine. Alternatively, the second mounting strip 16 may be attached to the pan 12 using a magnetic material or strong adhesive. The first mounting strip 18 can likewise be removably attached to the second mounting strip 16 using a variety of techniques. For example, using a detachable adhesive or a magnetic material attracted to the second mounting strip 16. In general, the first mounting strip 18 has a first surface removably attachable to a second surface located on the second mounting strip 16. The second mounting strip 16 in turn has a third surface that is attached to the oil pan 12. The catcher 10 may be attached to the oil-pan gasket (not shown) such that after the gasket is installed, the catcher 10 is positioned around the pan 12 beneath the flange 14, or, the catcher 10 may be cemented or otherwise attached to the pan 12.

Although discussed as being attached to the oil pan 12 beneath the flange 14, the oil-drip catcher 10 may be attached to the engine above the flange 14. In this position, the catcher 10 can absorb the oil leaking from the engine, but may not be able to absorb oil leaking from the oil-pan gasket (not shown).

FIG. 5 is a cross-sectional view of the oil-drip catcher 10 and the oil pan 12 of FIGS. 1-4 in a region where the pan 12 is near an engine-exhaust pipe 20 according to an embodiment of the invention. While the engine (not shown) is running, the pipe 20 can get quite hot. Therefore, a flame-resistant spacer 22 is placed between the catcher 10 and the pipe 20 to prevent the heat from the pipe 20 from burning or otherwise damaging the catcher 10. The spacer 22 may be attached to the catcher 10, to the pipe 20, or to both the catcher 10 and pipe 20. Alternatively, the spacer 22 may be wedged between the catcher 10 and the pipe 20 but attached to neither. The catcher may also have an inner 17 and outer 19 surface, with the inner surface being contoured to accommodate the shape of the pan in the region where the catcher 10 is mounted.

Still referring to FIG. 5, one can omit the spacer 22 in other embodiments. For example, the oil-drip catcher 10 may be formed from a flame-retardant material that can be near or actually touch the exhaust pipe 20 without burning. Alternatively, in a region where the pipe 20 is close enough to the oil pan 12 such that it is difficult or impossible to fit the catcher 10 between the pipe 20 and the pan 12 without the catcher 10 burning, one may omit a corresponding portion of the catcher 10. That is, one may dimension the absorbent material on the catcher with a recess, such as, for example, a notch in the region where the pipe 20 is close to the pan 12. In most such cases, because the pipe 20 is so close to the pan 12, the heat from the pipe 20 burns away most of the oil that leaks into or from this region before the oil can flow onto the sides of the pan 12 and drip onto the ground. Therefore, such notching often causes little or no reduction in the effectiveness of the catcher 10.

Although discussed with respect to the exhaust pipe 20, the spacer 22 or notching technique may be used to accommodate another item that may interfere with the placement or installation of the catcher 10. More generally, the catcher may be dimensional with a recess that forms a space so that the catcher can be fit on the oil pan without contacting an actual part of the vehicle.

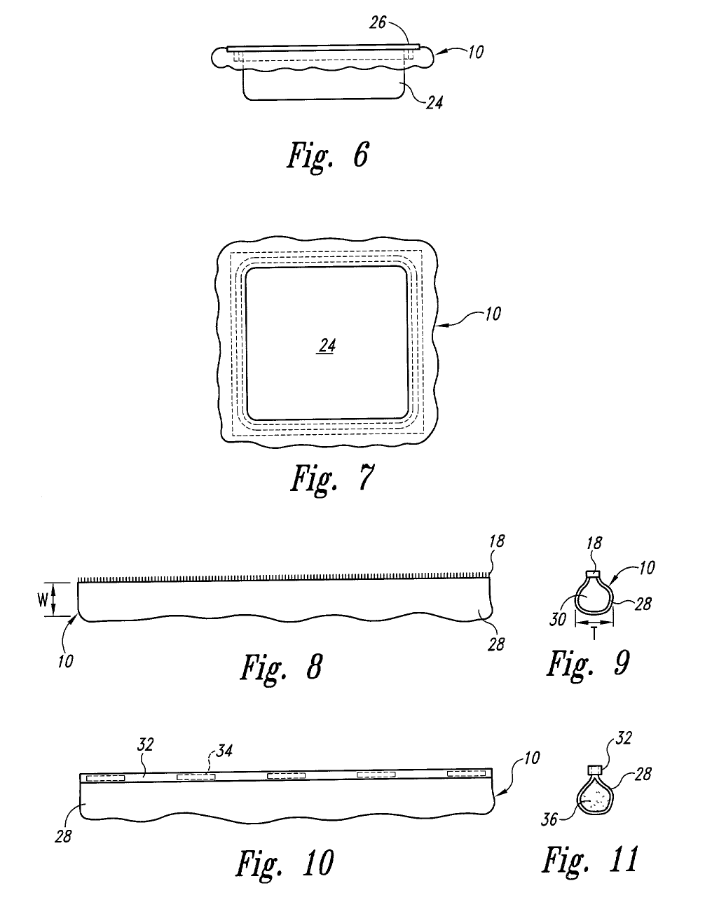

Referring to FIGS. 6-7, FIG. 6 is a side view and FIG. 7 is a bottom plan view of an oil-drip catcher 10 attached to a transmission oil pan 24 according to an embodiment of the invention. In one embodiment, the catcher 10 is similar to the catcher 10 of FIGS. 1-5. Like the engine oil pan 12 of FIGS. 1-5, the pan 24 has a flange 26 having holes that bolts (not shown) extend through to mount the pan 24 to the transmission housing (not shown). A transmission-oil-pan gasket (not shown) is disposed between the flange 26 and the transmission housing to form a leak proof seal there between. Unfortunately, as discussed above, sometimes the gasket wears out and allows oil to leak from the inside of the transmission onto the pan 24. In addition, oil may leak from other regions of the transmission, or engine oil may leak from the engine, and drip down the sides of the transmission toward the pan 24. But because the pan 24 is typically the lowest point of the transmission, leaking oil drips down the sides of and onto the pan 24 before it drips to the ground. Therefore, by mounting the catcher 10 beneath and around the flange 26, the catcher 10 absorbs the leaking oil before it can drip down the sides of the pan 24 and onto the ground, Furthermore, by mounting the catcher 10 close to the flange 26, the catcher 10 absorbs the leaking oil before it can be blown from the sides of the pan 24 onto the ground.

Referring to FIGS. 5 and 6, modifications similar to those discussed with respect to the oil-drip catcher 10 of FIG. 5 can be made to the catcher 10 of FIG. 6 to accommodate an exhaust pipe 20 or another item that may interfere with the placement or installation of the catcher 10.

Referring to FIGS. 8 and 9, FIG. 8 is a side view and FIG. 9 is a cross-sectional end view of the oil-drip catcher 10 of FIGS. 1-7 according to an embodiment of the invention. The catcher 10 includes at least one strip of oil-absorbent material 28 and the Velcro® strip 18. In one embodiment, the material 28 is Petroleum Sorbent folded (P-F1 550DD) material manufactured and sold by 3M Corporation. The strip 18 is attached to the material 28 using any compatible technique such as by adhesive or stitching.

Referring to FIG. 9, in one embodiment the oil-absorbent material 28 is rolled or folded and the ends are stitched together and to the strip 1.8. In other embodiments, however, a single unfolded sheet of the material 28 may be used or multiple folds or rolls of the material 28 may be used. In one embodiment, the oil-drip catcher 10 is formed from sections of 5-inch-by-50-foot rolls of the P-F1 550DD material. Furthermore, any compatible material may be disposed within the interior 30 formed by rolling or folding the material 28.

Still referring to FIGS. 8 and 9, although the oil-drip catcher 10 can have many dimensions, in one embodiment it has a width W of approximately three inches and a thickness T of approximately two inches. The catcher 10 also has a length L, which can be selected to accommodate the dimensions of a wide variety of selected vehicles. Alternatively, the length L may be long enough so the catcher can be cut to custom-size the catcher to fit any selected vehicle. Preferably, the catcher is part of a kit that includes instructions on how to mount the catcher or to customize it to fit a variety of vehicles.

Referring to FIGS. 10 and 11, FIG. 10 is a side view and FIG. 11 is a cross-sectional end view of the oil-drip catcher 10 of FIGS. 1-7 according to another embodiment of the invention. The catcher 10 of FIGS. 10 and 11 is similar to the catcher 10 of FIGS. 8 and 9 except that the second mounting strip 18 of FIGS. 8 and 9 is replaced by a mounting strip 32, which has openings 34 for receiving the pan mounting bolts (not shown) that mount the oil pan 12 of FIGS. 1-5 to the engine (not shown). In one embodiment, the strip 32 is positioned such that it lies either beneath or on top of the oil-pan gasket (not shown). Next, the gasket and attached catcher 10 are installed such that the bolts that mount the pan to the engine extend through the flange 14, through the openings 34, and into the engine. When the bolts are tightened, the flange 14 compresses the gasket and the strip 32 against the engine housing to form an oil proof seal. This secures the catcher 10 around the pan 12 and beneath the flange 14. In these embodiments, only a single mounting strip need be used to removably attach the absorbent material to the oil pan. In addition, referring to FIG. 11, in the illustrated embodiment, the region 30 is filled with a material 36. Any suitable material may be used for the material 36, such as more of the material 28 or another material.

Although described as being used with the engine oil pan 12, the oil-drip catcher 10 of FIGS. 10 and 11 may be modified for use with the transmission oil pan 24 (FIGS. 6 and 7), with a differential housing (not shown), or with other types of oil pans or oil seals, including, but not limited to, valve gasket covers, rocker-arm covers, a differential housing, an oil filter, and a bearing seal. Moreover, the invention is generally applicable to any machined assembly having component parts for storing or permitting a flow or fluid within the machined assembly. For example, the invention is readily adaptable to the cooling system of an engine such as a radiator or water pump where the catcher absorbs a coolant that leaks from these components. Again, the catcher would be attached to the lower portion of the radiator or the engine to capture the fluid leaked therefrom.

From the foregoing it will be appreciated that, although specific embodiments of the invention have been described herein for purposes of illustration, various modifications may be made without deviating from the spirit and scope of the invention.

1. A device for absorbing fluid leaked from a machined assembly, comprising:
an absorbent material that absorbs fluid leaked from the machined assembly; and
a mounting strip attached to a first part of the absorbent material, the mounting strip being removably attachable to an exterior portion of the machined assembly to position a second part of the absorbent material at a location where fluid leaked from the machined assembly is absorbed by the absorbent material.

2. The device of claim 1 wherein the mounting strip includes holes configured to receive a threaded screw or bolt to attach the absorbent material to the machined assembly.

3. The device of claim 1 wherein the mounting strip includes a magnetic surface to attach the absorbent material to the machined assembly.

4. The device of claim 1 wherein the mounting strip includes interlocking fabric hooks and loops to attach the absorbent material to the machined assembly.

5. The device of claim 1 wherein the location on the machined assembly is proximate to a joint between parts of the machined assembly.

6. The device of claim 5 wherein the machined assembly is selected from the group consisting of an engine and an automotive vehicle, and where the joint includes a gasket or seal between parts of the machined assembly.

7. The device of claim 6 wherein the gasket or seal is for a part selected from the group consisting of an oil pan, a valve cover, a transmission pan, a differential housing, a rocker-arm cover, an oil filter, and a bearing seal.

8. The device of claim 7 wherein the gasket or seal is for an oil pan.

9. The device of claim 7 wherein the gasket or seal is for a transmission pan.

10. The device of claim 7 wherein the mounting strip includes holes configured to receive a threaded screw or bolt for attachment of the part to the engine or automotive vehicle.

11. The device of claim 7 wherein the mounting strip includes a magnetic surface for attachment to the part to the engine or automotive vehicle.

12. The device of claim 7 wherein the mounting strip includes interlocking fabric hooks and loops for attachment of the part to the engine or automotive vehicle.

13. The device of claim 7 wherein the absorbent material is located at a lower portion of the engine to absorb fluid that flows down the sides of the engine toward the lower portion of the engine.

14. The device of claim 1 wherein the machined assembly includes a part of a cooling system for an engine and the fluid is a cooling fluid.

15. The device of claim 14 wherein the part of the cooling system is selected from the group consisting of s a radiator and a water pump and wherein the device is removably attached beneath the part.

16. A device for absorbing fluid leaked from a machined assembly, comprising:
an absorbent material that absorbs fluid leaked from the machined assembly;
a first mounting strip attached to a first part of the absorbent material,
a second mounting strip configured to be attached to an exterior portion of the machined assembly, and
the first mounting strip being removably attachable to the second mounting strip so that when the first mounting strip is attached to the second mounting strip, a second part of the absorbent material is positioned at a location where fluid leaked from the machined assembly is absorbed by the absorbent material.

17. The device of claim 16 wherein the first mounting strip has a first surface that attaches to a second surface present on the second mounting strip, and the second mounting strip has a third surface that attaches to the exterior portion of the machined assembly.

18. The device of claim 17 wherein first and second surfaces are comprised of interlocking fabric hooks and loops.

19. The device of claim 17 wherein first and second surfaces are comprised of a detachably adhesive material.

20. The device of claim 17 wherein the first and second surfaces are comprised of magnetically attracted materials.

21. The device of claim 17 wherein the second mounting strip includes holes configured to receive a threaded screw or bolt to attach the second mounting strip to the machined assembly and wherein the first and second surfaces are comprised of a material selected from the group consisting of interlocking fabric hooks and loops, detachably adhesive materials, and magnetically attracted materials.

22. The device of claim 17 wherein the third surface is comprised of a magnetic material and wherein the first and second surfaces are comprised of a material selected from the group consisting of interlocking fabric hooks and loops, detachably adhesive materials, and magnetically attracted materials.

23. The device of claim 17 wherein the third surface is comprised of an adhesive material and wherein the first and second surfaces are comprised of a material selected from the group consisting of interlocking fabric hooks and loops, detachably adhesive materials, and magnetically attracted materials.

24. The device of claim 17 wherein the second part of the absorbent material is positioned proximate to a joint between parts of the machined assembly when the first mounting strip is attached to the second mounting strip and the second mounting strip is attached to the machined assembly.

25. The device of claim 24 wherein the machined assembly is selected from the group consisting of an engine and an automotive vehicle, and where the joint includes a gasket or seal between parts of the machined assembly.

26. The device of claim 24 wherein the gasket or seal is for a part selected from the group consisting of an oil pan, a valve cover, a transmission pan, a differential housing, a rocker-arm cover, and a bearing seal.

27. The device of claim 26 wherein the gasket or seal is for an oil pan.

28. The device of claim 26 wherein the gasket or seal is for a transmission pan.

29. The device of claim 26 wherein first and second surfaces are comprised of interlocking fabric hooks and loops.

30. The device of claim 26 wherein first and second surfaces are comprised of a detachably adhesive material.

31. The device of claim 26 wherein the first and second surfaces are comprised of magnetically attracted materials.

32. The device of claim 26 wherein the second mounting strip includes holes configured to receive a threaded screw or bolt to attach the second mounting strip to the machined assembly and wherein the first and second surfaces are comprised of a material selected from the group consisting of interlocking fabric hooks and loops, detachably adhesive materials, and magnetically attracted materials.

33. The device of claim 26 wherein the third surface is comprised of a magnetic material and wherein the first and second surfaces are comprised of a material selected from the group consisting of interlocking fabric hooks and loops, detachably adhesive materials, and magnetically attracted materials.

34. The device of claim 26 wherein the third surface is comprised of an adhesive material and wherein the first and second surfaces are comprised of a material selected from the group consisting of interlocking fabric hooks and loops, detachably adhesive materials, and magnetically attracted materials.

35. The device of claim 26 wherein the absorbent material is located at a lower portion of an engine to absorb fluid that flows down the sides of the engine toward the lower portion of the engine.

36. The device of claim 25 wherein the machined assembly includes a part of a cooling system for an engine and the fluid is a cooling fluid.

37. The device of claim 36 wherein the part of the cooling system is selected from the group consisting of a radiator and a water pump and wherein the device is removably attached beneath the part.

38. The device of claim 26 wherein the absorbent material is rolled or folded to form an interior space enveloped by the roll or fold of material.

39. The device of claim 38 wherein the interior space is filled with a fluid absorbing material.

40. The device of claim 39 wherein the fluid absorbing material is the same as the absorbent material in the roll or fold of material.

41. The device of claim 26 wherein the absorbent material is shaped to fit beneath the flange of an oil pan or transmission pan of an internal combustion engine.

42. The device of claim 41 wherein the absorbent material has a recessed dimension that forms a space between the absorbent material and an external part of the vehicle to permit the device to be attached to the oil pan or transmission pan without contacting the external part of the vehicle.

43. The device of claim 42 wherein the recessed dimension is sized to prevent combustive heat from being transferred from the external part to the absorbent material.

44. The device of claim 41 wherein the device has a length and a width, the length being sized to fit around the oil pan or transmission pan of a selected vehicle.

45. The device of claim 41 wherein the device has an inner surface and an outer surface, the inner surface being contoured to accommodate the shape of the flange of the oil pan or transmission pan.

46. A kit comprising the device of claim 41 and instructions for mounting the device.

47. The kit of claim 46 wherein the device is dimensioned to fit a selected vehicle.

48. The kit of claim 46 wherein the device is dimensioned so that it can be cut to accommodate dimensions for a plurality of oil pans or transmission pans.

49. A device for absorbing oil or transmission fluid leaked from an oil pan or transmission pan, comprising:
an absorbent material that absorbs the oil or transmission fluid leaked from the oil pan or transmission pan;
a first mounting strip attached to a first part of the absorbent material and, the first mounting strip having a first surface comprised of interlocking fabric hooks and loops;
a second mounting strip having a second surface comprised of interlocking fabric hooks and loops and a third surface that configured to attach to an oil pan or transmission pan, and
the first surface of the first mounting strip being removably attachable to the second surface of the second mounting strip so that when the second mounting strip is attached to the oil pan or transmission pan and the first mounting strip is attached to the second mounting strip, a second part of the absorbent material is positioned beneath a gasket of the oil pan to absorb the oil or transmission fluid leaked from the automotive component.

50. A method of absorbing fluid that leaks from a machine assembly comprising: attaching the device of claim 1 to a machine assembly.

51. A method of absorbing fluid that leaks from a machine assembly comprising: attaching the device of claim 16 to a machine assembly.

52. A method of absorbing fluid that leaks from a machine assembly comprising: attaching the device of claim 49 to the transmission pan or oil pan.
